(19) United States
(12) Patent Application Publication
(10) Pub. No.: US 2025/0379950 A1
(43) Pub. Date: Dec. 11, 2025

(54) IMAGE FORMING APPARATUS AND RECORDING MEDIUM

(71) Applicant: Konica Minolta, Inc., Tokyo (JP)

(72) Inventor: Tsumoru MATSUURA, Toyohashi-shi (JP)

(21) Appl. No.: 19/225,458

(22) Filed: Jun. 2, 2025

(30) Foreign Application Priority Data
Jun. 5, 2024 (JP) 2024-091108

(51) Int. Cl. H04N 1/32; H04N 1/00

(52) U.S. Cl. CPC H04N 1/32122; H04N 1/00344

(57) ABSTRACT

Disclosed is an image forming apparatus that includes: a unit; and an image forming apparatus main body to which the unit is attached, the image forming apparatus including: an image former that forms an image on a sheet; and a hardware processor that causes the image former to form, on the sheet, a print image including state information indicating a state of the unit to be handed over from an image forming apparatus from which the unit is removed to an image forming apparatus to which the unit is attached in refurbishing work, and stores at least a portion of the print image indicating the state information in an external storage device.

### BACKGROUND OF THE INVENTION

### Technical Field

The present invention relates to an image forming apparatus and a recording medium.

### Description of Related Art

In general, an image forming apparatus is formed by attaching a plurality of units to an image forming apparatus main body. Each of the units is a consumable and is replaced at appropriate timing.

In this regard, Japanese Unexamined Patent Publication No. 2019-64190 describes an image forming apparatus that acquires, before replacement of a component in the image forming apparatus, information indicating the status of use of the component and holds the information in its own nonvolatile storage section.

Japanese Unexamined Patent Publication No. 2013-41193 describes an image forming apparatus in which a memory included in a replacement part stores information indicating usage information on the replacement part.

In recent years, it has been desired to eliminate wasteful disposal in order to realize a recycling society. Therefore, a recycling operation is performed in which a reusable unit having a remaining lifetime is removed from an image forming apparatus body to be discarded, and the unit is attached to an image forming apparatus main body of another image forming apparatus as a reproducing apparatus. In the recycling operation, it is necessary to take over the counter information regarding the use history of the used unit when the used unit is attached to the reproducing apparatus.

In a case where the counter information is stored in the storage device of the image forming apparatus main body, the operator takes over the counter information by the following method in the reproduction work. Specifically, the operator prints, on a sheet, a quick response (QR) code (R) including counter information of the unit to be removed in the image forming apparatus that is a provider of the unit. Next, the operator causes the image forming apparatus to which the unit is to be provided to acquire the counter information of the unit by reading the QR code printed on the sheet.

### SUMMARY OF THE INVENTION

However, when the image forming section of the image forming apparatus of the providing source has a problem, the QR code including the counter information cannot be printed on a sheet. In this case, there is a problem that the counter information of the used unit cannot be efficiently taken over in the recycling operation of the image forming apparatus.

An object of the present invention is to provide an image forming apparatus and a recording medium with which information indicating a state of a unit removed from a providing source apparatus can be suitably handed over to a providing destination apparatus.

To achieve at least one of the abovementioned objects, according to an aspect of the present invention, an image forming apparatus reflecting one aspect of the present invention is an image forming apparatus that comprises: a unit; and an image forming apparatus main body to which the unit is attached, the image forming apparatus comprising:
an image former that forms an image on a sheet; and
a hardware processor that causes the image former to form, on the sheet, a print image including state information indicating a state of the unit to be handed over from an image forming apparatus from which the unit is removed to an image forming apparatus to which the unit is attached in refurbishing work, and stores at least a portion of the print image indicating the state information in an external storage device.

To achieve at least one of the abovementioned objects, according to an aspect of the present invention, a recording medium reflecting one aspect of the present invention is a non-transitory recording medium storing a computer readable program for a computer of an image forming apparatus that comprises: a unit; an image forming apparatus main body to which the unit is attached; and an image former to form an image on a sheet, the program causing the computer to
cause the image former to form, on the sheet, a print image including state information indicating a state of the unit to be handed over from an image forming apparatus from which the unit is removed to an image forming apparatus to which the unit is attached in refurbishing work, and stores, in an external storage device, at least a portion of the print image indicating the state information.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic configurational view of the image forming apparatus in the present invention;

FIG. 2 is a block diagram illustrating the functional configuration of the image forming apparatus;

FIG. 3 is a flowchart showing the flow of the counter information output process

FIG. 4 is a diagram illustrating a sheet on which the handover information is printed;

FIG. 5 is a flowchart illustrating a flow of the counter information output process of the modification example 1; and

FIG. 6 is a flowchart illustrating the flow of counter information output process of modification example 2.

### DETAILED DESCRIPTION

Hereinafter, embodiments of the present invention will be described with reference to the drawings. However, the scope of the invention is not limited to the disclosed embodiments.

### <1. Configuration of Image Forming Apparatus>

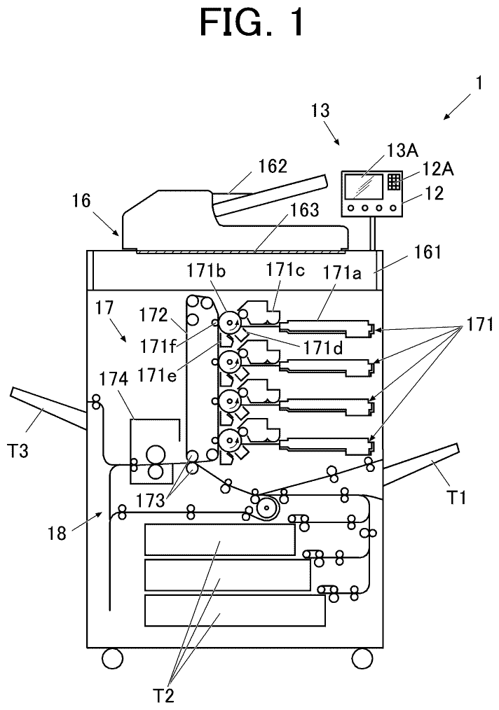

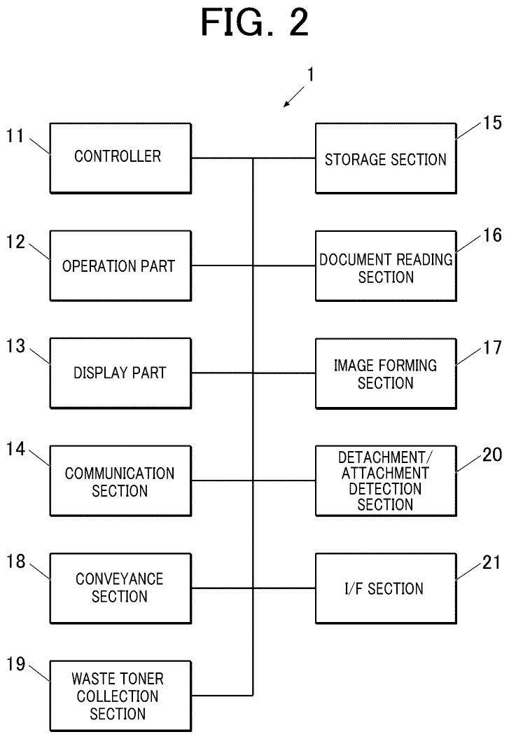

FIG. 1 is a schematic configuration diagram of an image forming apparatus 1 according to the present embodiment. FIG. 2 is a block diagram illustrating the functional configuration of the image forming apparatus 1.

The image forming apparatus 1 is an MFP having a copy function, a scan function, a facsimile function, and the like in addition to an image formation function.

In the recycling work of the image forming apparatus 1, the operator of the manufacturer takes out a reusable used unit from the image forming apparatus 1 (apparatus to be discarded) whose main body is a discarding target. Next, the operator attaches the used unit removed from the apparatus to be discarded to another reusable image forming apparatus 1. The manufacturer sells or rents the other image forming apparatus 1 to which the used unit is attached as a reproducing apparatus.

The image forming apparatus 1 includes a controller 11 (hardware processor), an operation part 12, a display part 13, a communication section 14, a storage section 15, a document reading section 16, an image forming section (image former) 17, a conveyance section 18, a waste toner collection section 19, a detachment/attachment detection section 20, and an I/F section 21.

The controller 11 includes a central processing unit (CPU), a random access memory (RAM), and the like.

The CPU of the controller 11 reads a program stored in the storage section 15, loads the program to the RAM, and controls the components of the image forming apparatus 1 according to the loaded program. For example, the controller 11 performs image processing on image data of a job on the basis of settings of the job input from the outside via the communication section 14. Next, the controller 11 causes the conveyance section 18 to sheet feed, and causes the image forming section 17 to form and fix an image on the sheet.

The operation part 12 includes operation keys 12A, and a touch screen integrally formed with the display part 13, and outputs a signal corresponding to a user input thereon to the controller 11.

The display part 13 includes a liquid crystal display (LCD) panel 13A and the like, and displays display information such as an operation screen in accordance with an instruction from the controller 11.

The communication section 14 includes a network card, and is connected to a communication network so as to transmit information to and receive information from an external device on the communication network.

The storage section 15 includes a storage device such as a nonvolatile semiconductor memory and a hard disk.

The storage section 15 stores programs and files readable by the controller 11.

The storage section 15 stores, for each detachable unit included in the image forming apparatus 1, state information indicating the state of the unit. The state information of the unit is, for example, counter information of the unit. The counter information of the unit is initialized to “0” again, for example, when the unit is replaced with a new one. The counter information of the units will be described in detail later. The state information of the unit may be a value or the like obtained by detecting deterioration of a main part of the unit with a sensor.

The document reading section 16 includes an automatic document feeder, a scanner section 161, a placement tray 162 on which a document sheet is placed, a platen glass 163, and the like.

The automatic document conveyance section includes a mechanism for conveyance of a document sheet, a document conveyance roller, and the like, and conveys the document sheet to a predetermined conveyance route under the control of the controller 11.

The scanner 161 includes a light source, an optical system such as a reflecting mirror, and an imaging element, and reads an image of a document sheet conveyed along a predetermined conveyance route or a document sheet placed on the glass 163.

The image forming section 17 forms and fixes an image of four colors of C, M, Y, and K on a sheet, according to the pixel values of the four colors of each pixel of the image data subjected to image processing.

As illustrated in FIG. 1, the image forming section 17 includes four writing units 171, an intermediate transfer belt 172, a secondary transfer roller 173, and a fixing unit 174.

Four writing units 171 are arranged in series (tandem) along the belt plane of the intermediate transfer belt 172 for the four colors of C, M, Y, and K as single colors to form images in the C, M, Y, and K colors on a sheet.

The writing unit 171 includes an exposure section 171a, a photosensitive drum 171b, a developing section 171c, a charging section 171d, a cleaning section 171e, and a primary transfer roller 171f.

The photosensitive drum unit 171b includes a rotating conductive cylindrical body (photoreceptor). The charging section 171d charges the photoreceptor. Under the control of the controller 11, the exposure section 171a drives the light source or the like according to image data, and scans and irradiates the photoreceptor charged by the charging section 171d with laser light so as to expose the photoreceptor. Under the control of the controller 11, the developing section 171c supplies toner onto the photoreceptor using the charged developing roller, and develops an electrostatic latent image formed on the photoreceptor by exposure. The images formed on the respective photoreceptors of the four writing units 171 are sequentially superimposed and transfer (primary transfer) onto the intermediate transfer belt 172 by the respective primary transfer roller 171f. Thus, a toner image of the individual colors is formed on the intermediate transfer belt 172. After the primary transfer, the cleaning section 171e removes the toner remaining on the photoreceptor.

The intermediate transfer belt 172 is an endless belt extending around a plurality of rollers, and rotates in accordance with rotations of the rollers under the control of the controller 11.

Under the control of the controller 11, the secondary transfer roller 173 transfer (secondary-transfer) the toner image formed on the intermediate transfer belt 172 onto a sheet conveyed from the manual sheet feed tray T1 or the sheet feed tray T2.

The fixing unit 174 includes a heating roller and a pressure roller.

Under the control of the controller 11, the fixing unit 174 applies heat and pressure to the sheet with the image formed thereon so as to fix the image on the sheet.

The conveyance section 18 includes a sheet feed roller and the like, and conveys a sheet from the manual sheet feed tray T1 or the sheet feed tray T2 to the image forming section 17 by the sheet feed roller in accordance with an instruction from the controller 11. The conveyance section 18 ejects the sheet subjected to fixing by the fixing unit 174 to the sheet ejection tray T3. When performing double-sided printing, the conveyance section 18 flips the sheet with an image formed on its surface, and conveys the sheet again to the image forming section 17.

The waste toner collection section 19 includes a waste toner conveyance unit and a waste toner collection container.

The waste toner collection section 19 conveys the waste toner removed in the image forming section 17 by a waste toner conveyance unit, and collects the waste toner in a waste toner collection container.

The detachment/attachment detection section 20 detects, for each detachable unit, that the unit has been attached to the main body of the image forming apparatus 1 and that the unit has been removed from the main body of the image forming apparatus 1. The detachment/attachment detection section 20 outputs a detection result to the controller 11.

The I/F section 21 is an interface (e.g., a universal serial bus (USB) interface) for connecting to an external device.

### <2. Unit Counter Information>

The counter information of the unit stored in the storage section 15 is information indicating the degree of wear of the unit.

The units detachable from the main body of the image forming apparatus 1 are operation key 12A, an LCD panel 13A, a photosensitive drum unit 171b, a developing unit of a developing section 171c, a toner unit of the developing section 171c, a transfer belt unit including an intermediate transfer belt 172, a transfer roller unit including a secondary transfer roller 173, a fixing unit 174, a waste toner conveyance unit of a waste toner collection section 19, and the like.

The counter information of the unit includes at least one of the number of times of pressure contact, a travel distance, a travel time, a predetermined temperature cumulative time, a maximum sheet passing distance, the number of printed (image formation) sheets, and an energization time.

The number of times of pressure contact is a cumulative number of times of pressure contact from a time point when the unit is new to a current time point. The number of times of pressure contact is, for example, information corresponding to the fixing unit 174 or the like.

The travel distance is an accumulated travel distance from a time point when the unit is new to a current time point. The travel distances are, for example, information corresponding to the photosensitive drum unit 171b, the transfer belt unit, the transfer roller unit, the fixing unit 174, and the like.

The running time is the cumulative running time from when the unit is new to the present time. The travel time is, for example, information corresponding to the photosensitive drum unit 171b, the transfer belt unit, the transfer roller unit, the fixing unit 174, or the like.

The predetermined temperature cumulative time is a cumulative time of the predetermined temperature at the present time from a state where the unit is new. The predetermined temperature cumulative time is, for example, information corresponding to the fixing unit 174 or the like.

The maximum sheet passing distance is a maximum distance that the unit has passed from a brand-new state to the present time. For example, it is information corresponding to the fixing unit 174 or the like.

The number of printed sheets is the cumulative number of sheets printed from when the unit is brand-new to the current time. The number of printed sheets is, for example, information corresponding to the photosensitive drum unit 171b, the developing unit, the toner unit, the transfer belt unit, the transfer roller unit, the fixing unit 174, the waste toner conveyance unit, or the like.

The energization time is a cumulative operation time from when the unit is new to the current time. The energization time is, for example, information corresponding to an operation key 12A, an LCD panel 13A, or the like.

### <3. Operation of Image Forming Apparatus>

Next, operation of the image forming apparatus 1 will be described.

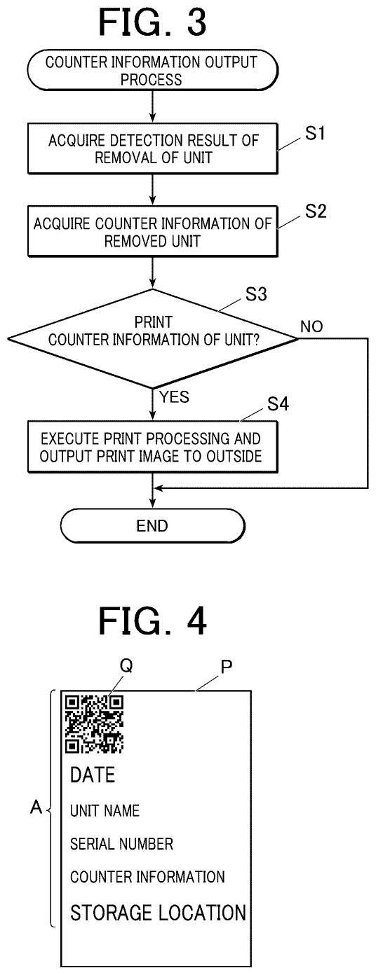

FIG. 3 is a flowchart of a counter information output process executed by the image forming apparatus 1 (apparatus to be discarded) whose main body is a discarding target.

(counter information output process)

In the refurbishing work (refurbishing work) of the image forming apparatus 1, an operator sets the operation mode of the apparatus to be discarded to the refurbishing mode. The refurbished mode is a special mode that cannot be used by a general user, and is a mode exclusively for a reuse operation of a unit of the image forming apparatus 1.

Next, the operator takes out the unit to be reused from the main body of the apparatus to be discarded.

When the unit is removed, the controller 11 of the apparatus to be discarded acquires a detection result indicating that the unit has been removed from the detachment/attachment detection section 20 (step S1).

Next, the controller 11 of the apparatus to be discarded acquires the counter information of the removed unit from the storage section 15 (step S2).

Next, the controller 11 of the apparatus to be discarded determines whether or not to print the QR code including the counter information of the unit acquired in step S2 on the sheet by the image forming section 17 based on the instruction operation or the like of the user received via the operation part 12 (step S3).

If the QR code including the counter information of the unit acquired in step S2 is not to be printed (NO in step S3), the controller 11 of the apparatus to be discarded ends the counter information output process.

On the other hand, when a QR code including the counter information of the unit acquired in step S2 is to be printed (step S3; YES), the controller 11 of the apparatus to be discarded generates a QR code including the counter information of the unit acquired in step S2. Next, as illustrated in FIG. 4, the controller 11 of the apparatus to be discarded causes the image forming section 17 to print the transfer information A including the generated QR code Q on the sheet P. In addition, the controller 11 of the apparatus to be discarded generates an electronic file including a print image for printing the handover information A, outputs (stores) the electronic file to (in) an external storage device (e.g., a USB memory) via the I/F section 21 (step S4), and ends the counter information output process. In step S4, the controller 11 of the apparatus to be discarded may store, in an external storage device, a QR code image which is a portion including at least the state information of the unit in the print image for printing the transfer information A.

As illustrated in FIG. 4, the transfer information A includes the QR code Q including the counter information of the unit acquired in step S2, the date on which the transfer information A was printed on the sheet P, the name of the unit, the serial number, the counter information, the storage location, and the like. The transfer information A may include an expiration date of the unit.

That is, in step S4, the controller 11 allows the image forming section 17 to form, on a sheet, a print image including state information indicating the state of the unit to be handed over from the image forming apparatus (apparatus to be discarded) from which the unit is removed to the image forming apparatus (reproducing apparatus) to which the unit is attached. In addition, the controller 11 stores, in the external storage device, at least the QR code image that is a portion of the printed image indicating the state information of the unit.

The operator may print the print image output to the external storage device in step S4 by another printing means. Thus, the counter information of the unit can be taken over to the reproducing apparatus even when the take-over information A cannot be printed due to the occurrence of a failure in the image forming section 17 of the apparatus to be discarded.

In step S2 of the counter information output process, the controller 11 of the apparatus to be discarded may perform the following process. Specifically, the controller 11 displays the counter information of the removed unit on the display part 13. Next, the controller 11 receives an operation of selecting counter information to be handed over to the reproducing apparatus from the counter information of the removed unit by the user via the operation part 12. In this case, in step S4, the controller 11 generates a QR code including the counter information selected by the user. Next, the controller 11 causes the image forming section 17 to print the transfer information including the generated QR code on the sheet P. In addition, the controller 11 generates an electronic file including a print image for printing the handover information, and stores the electronic file in the external storage device via the I/F section 21.

In the above-described processing for outputting counter information, when a plurality of units have been removed, in step S4, the controller 11 of the apparatus to be discarded generates, for each of the removed units, a QR code including respective counter information.

Next, the controller 11 of the apparatus to be discarded puts together the respective handover information including the respective QR codes into an electronic file. Next, the controller 11 stores the electronic file in an external storage device via the I/F section 21. That is, when there are a plurality of units to be removed from the image forming apparatus 1 as a apparatus to be discarded, the controller 11 stores, in an external storage device, portions (QR code images) indicating a plurality of pieces of state information respectively corresponding to the plurality of units as one file.

After counter information output process, the operator affixes the sheet printed in step S4 to a corresponding unit, and stores it as a stock of a used unit.

Next, the operator takes out the used unit stored as stock and the sheet on which the transfer information on the unit is printed from the storage place. Next, the operator attaches the taken used unit to the main body of another image forming apparatus 1 (reproducing apparatus). Next, the operator reads the QR code printed on the sheet with the document reading section 16 of the reproducing apparatus. Thus, the reproducing apparatus acquires the counter information on the used unit and stores the acquired counter information in the storage section 15.

By the above-described reproducing operation, the counter information of the attached used unit can be taken over in the reproducing apparatus.

### <4. Modification Example>

Although the present embodiment has been described above, the specific configuration is not limited to the above-described the present embodiment and can be changed without departing from the spirit and scope of the invention. Hereinafter, modification example of the present embodiment will be described. In the modification example, components similar to those of the embodiment described above are appended with the same reference codes, and descriptions thereof are omitted.

### (Modification Example 1)

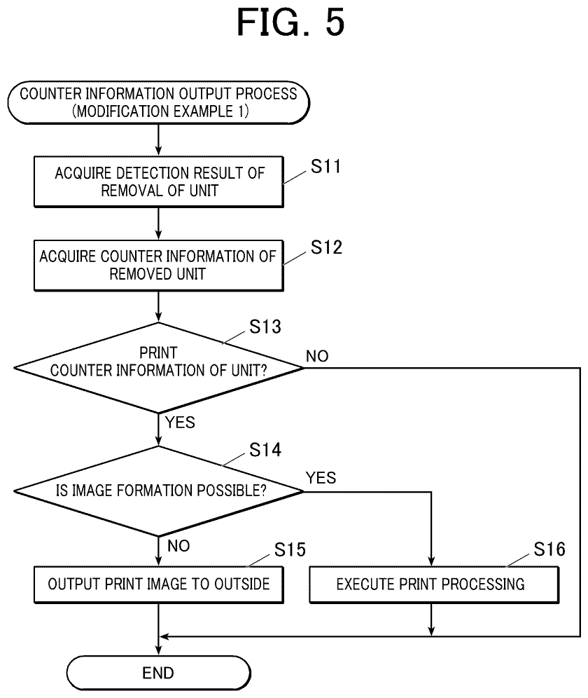

FIG. 5 is a flowchart of a counter information output process executed by the apparatus to be discarded according to the modification example 1.

In the counter information output process of modification example 1, the controller 11 of the apparatus to be discarded executes steps S1 to S3 similar to steps S11 to S13 of the above-described embodiment.

When the QR code including the counter information of the unit acquired in step S12 is to be printed (step S13; YES), the controller 11 of the apparatus to be discarded determines whether the image forming section 17 is in a printable state (step S14).

When a failure or the like has occurred in the image forming section 17 and the image formation cannot be performed (step S14; NO), the controller 11 of the apparatus to be discarded does not execute the print processing by the image forming section 17. In addition, the controller 11 generates an electronic file including a print image for printing the take-over information, outputs the electronic file to an external storage device via the I/F section 21 (step S15), and ends the counter information output process.

That is, when image formation by the image forming section 17 is not possible, the controller 11 stores, in the external storage device, at least the QR code image that is a portion indicating the state information of the unit in the print image including the state information of the unit.

On the other hand, if the image forming section 17 can form an image (YES in step S14), the controller 11 of the apparatus to be discarded causes the image forming section 17 to print the transfer information including the QR code including the counter information of the unit acquired in step S12 on a sheet (step S16), and ends the counter information output process.

### (Modification Example 2)

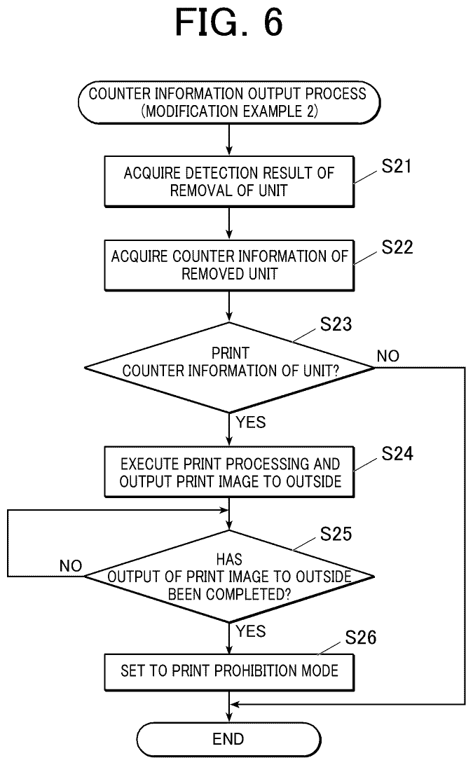

FIG. 6 is a flowchart of a counter information output process executed by the apparatus to be discarded according to the modification example 2.

In the counter information output process of modification example 2, the controller 11 of the apparatus to be discarded executes steps S1 to S4 similar to steps S21 to S24 of the above-described embodiment.

Next, the controller 11 of the apparatus to be discarded determines whether output of the electronic file including the printed image to the external storage device has been completed, that is, whether the electronic file has been stored in the external storage device (step S25).

When the outputting of the electronic file is not completed (step S25; NO), the controller 11 of the apparatus to be discarded returns the counter information output process to step S25.

On the other hand, when the outputting of the electronic file is completed (step S25; YES), the controller 11 of the apparatus to be discarded sets the operation mode of the apparatus to be discarded to a print prohibition mode in which printing by the image forming section 17 is prohibited (printing is restricted) (step S26), and ends the counter information output process.

That is, in the counter information output process of the modification example 3, the controller 11 of the apparatus to be discarded restricts the image formation processing by the image forming section 17 after storing the portion (QR code image) indicating the state information of the unit in the external storage device. The controller 11 functions as a limiting section.

Thus, it is possible to prevent the counter information included in the electronic file stored in the external storage device and the counter information after the print processing executed after the electronic file is stored in the external storage device from being different from each other, thereby preventing the incorrect counter information from being taken over to the reproducing apparatus.

### <5. Effect>

As described above, the image forming apparatus 1 according to the present embodiment is an image forming apparatus including a unit and an image forming apparatus main body to which the unit is attached.

The image forming apparatus 1 includes an image forming section 17 that forms an image on a sheet.

An image forming apparatus 1 includes a controller 11 which causes an image forming section 17 to form, on a sheet, a print image including state information indicating a state of a unit taken over from an image forming apparatus from which the unit is removed to an image forming apparatus to which the unit is attached in refurbishing work, and stores a part (QR code image) indicating at least the state information of the unit in the print image in an external storage device.

Therefore, even in a case where the image forming section 17 of the apparatus to be discarded has a problem and thus the handover information cannot be printed, the operator can hand over the counter information of the unit to the reproducing apparatus based on the QR code image stored in the external storage device. Thus, the information (counter information) indicating the state of the unit removed from the provision source apparatus can be suitably handed over to the provision destination apparatus.

In the image forming apparatus 1 according to the present embodiment, when image formation by the image forming section 17 is not possible, the controller 11 stores, in an external storage device, at least a portion (QR code image) indicating state information of a unit in a print image including the state information.

Therefore, when the image forming section 17 of the apparatus to be discarded has a problem and the handover information cannot be printed, the operator can hand over the counter information of the unit to the reproducing apparatus on the basis of the QR code image stored in the external storage device.

In the image forming apparatus 1 according to the present embodiment, when there are a plurality of units to be removed from the image forming apparatus 1, the controller 11 stores portions (QR code images) indicating a plurality of pieces of state information respectively corresponding to the plurality of units as one file in an external storage device.

Therefore, a plurality of pieces of state information respectively corresponding to the plurality of units can be stored in the external storage device at a time.

The image forming apparatus 1 according to the present embodiment includes the restriction section (controller 11) that restricts the image formation processing by the image forming section 17 after the controller 11 stores the portion (QR code image) indicating the state information of the unit in the external storage device.

Therefore, it is possible to prevent the counter information included in the QR code stored in the external storage device and the counter information after the printing process executed after the QR code is stored in the external storage device from being different from each other, so that it is possible to prevent erroneous counter information from being taken over to the reproducing apparatus.

The description in the above embodiment is an example of the image forming apparatus and program according to the present invention, and the present invention is not limited thereto. The detailed configuration and detailed operation of each device constituting the system can also be appropriately changed without departing from the spirit of the present invention.

For example, in the above-described embodiment and modification example, the controller 11 may generate a two dimensional code other than the QR code including the counter information of the unit, instead of the QR code including the counter information of the unit removed from the image forming apparatus main body.

Further, in the above-described embodiment and modification example, the program for executing each process in each device may be stored in a portable recording medium. In addition, a carrier wave may be applied as a medium for providing program data via a communication line.

As for the other detailed configurations and the detailed operations of devices forming the analysis processing system, modifications can be made as needed within the scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2024-091108, filed on Jun. 5, 2024, including description, claims, drawings and abstract is incorporated herein by reference.

What is claimed is:

1. An image forming apparatus that comprises: a unit; and an image forming apparatus main body to which the unit is attached, the image forming apparatus comprising:
an image former that forms an image on a sheet; and
a hardware processor that causes the image former to form, on the sheet, a print image including state information indicating a state of the unit to be handed over from an image forming apparatus from which the unit is removed to an image forming apparatus to which the unit is attached in refurbishing work, and stores at least a portion of the print image indicating the state information in an external storage device.

2. The image forming apparatus according to claim 1, wherein the hardware processor stores at least the portion of the print image indicating the state information in the external storage device when image formation by the image former is not possible.

3. The image forming apparatus according to claim 1, wherein in a case where a plurality of units are removed from the image forming apparatus, each of the units being the unit, the hardware processor stores, in the external storage device, portions indicating a plurality of pieces of the state information respectively corresponding to the plurality of units as one file.

4. The image forming apparatus according to claim 1, wherein the hardware processor restricts image formation processing by the image former after storing the portion indicating the state information in the external storage device.

5. A non-transitory recording medium storing a computer readable program for a computer of an image forming apparatus that comprises: a unit; an image forming apparatus main body to which the unit is attached; and
an image former to form an image on a sheet, the program causing the computer to cause the image former to form, on the sheet, a print image including state information indicating a state of the unit to be handed over from an image forming apparatus from which the unit is removed to an image forming apparatus to which the unit is attached in refurbishing work, and stores, in an external storage device, at least a portion of the print image indicating the state information.
